(19) United States
(12) Patent Application Publication
(10) Pub. No.: US 2014/0307181 A1
(43) Pub. Date: Oct. 16, 2014

(54) TOUCH PANEL AND TOUCH DISPLAY DEVICE

(71) Applicant: SHENZHEN O-FILM TECH CO., LTD., Guangdong (CN)

(72) Inventors: Genchu TANG, Guangdong (CN); Shengcai DONG, Guangdong (CN); Wei LIU, Guangdong (CN); Bin TANG, Guangdong (CN)

(73) Assignee: SHENZHEN O-FILM TECH CO., LTD., Guangdong (CN)

(21) Appl. No.: 14/243,197

(22) Filed: Apr. 2, 2014

(30) Foreign Application Priority Data
Apr. 12, 2013 (CN) 201310127471.4

(51) Int. Cl. G06F 3/041

(52) U.S. Cl. CPC G06F 3/041
USPC 349/12

(57) ABSTRACT

A touch panel includes: a glass cover plate including a display area and a non-display area located at an outer edge of the display area; and a touch sensing module laminated on the glass cover plate. The touch sensing module includes a first conductive layer and a second conductive layer. The first conductive layer includes a plurality of first conductive strips; the second conductive layer includes a plurality of second conductive strips. The touch sensing module includes a sensing area defined by edges of the first conductive layer and the second conductive layer. The sensing area includes a visual area and a non-visual area located at an outer edge of the visual area. A projection of the visual area on the glass cover plate coincides with the display area, a projection of the non-visual area on the glass cover plate falls within the non-display area.

### FIELD OF THE INVENTION

The present disclosure relates to touch technologies, and more particularly relates to a touch panel and a touch display device having the touch panel.

### BACKGROUND OF THE INVENTION

Currently, a touch screen has been applying to more and more electronic devices, such as mobile phones, tablets, MP4, e-books and so on. The touch screen is a sensing device capable of receiving touch input signals. The touch screen brings a new appearance for information exchange, which is a new appealing information interactive device. The development of touch screen technology has aroused widespread concern from information media on home and abroad; and the touch panel technology has become a booming high-tech industry in the optoelectronics. However, the conventional touch screen is usually plug-in or embedded the display of the electronic device. Since the sensing area of the touch screen faces the display, the touch operation of the user can only be limited to the area of the touch screen facing the display, thus resulting a poor user experience and difficulty to meet the needs of users.

The ITO conductive layer is a crucial component for the touch screen. Although the manufacturing technology of the touch screen has been rapidly developed, taking the projected capacitive screen as an example, the basic manufacturing process for the ITO layer does not change in recent years. The process inevitably includes the ITO coating and the ITO patterning. The conventional manufacturing process inevitably needs etching, during which massive ITO and conductive materials are wasted. Indium is a rare earth metal and has a rare reserve in nature. In recent years, the cost of indium materials has been sharply raised, which inevitably lead to rise of the production cost. In addition, in order to achieve low square resistance, the thickness of the ITO conductive layer must be increased, which not only further increases the cost, but also decreases the transmittance. Furthermore, the ITO conductive layer is easy to crack, such that the performance of the touch screen is unstable.

### SUMMARY OF THE INVENTION

The present disclosure is directed to a touch panel which can enhance the user's experience and a touch display device having the touch panel.

A touch panel includes: a glass cover plate including a display area and a non-display area located at an outer edge of the display area; and a touch sensing module laminated on the glass cover plate. The touch sensing module includes a first conductive layer and a second conductive layer laminated in a thickness direction of the glass cover plate. The first conductive layer includes a plurality of first conductive strips extending along a first direction, the plurality of first conductive strips are spaced and insulated from each other; the second conductive layer includes a plurality of second conductive strips extending along a second direction, the plurality of second conductive strips are spaced and insulated from each other. Projections of the first conductive strips on a plane where the second conductive strips are located intersect the second conductive strips. The touch sensing module includes a sensing area defined by edges of the first conductive layer and the second conductive layer. The sensing area includes a visual area and a non-visual area located at an outer edge of the visual area. A projection of the visual area on the glass cover plate coincides with the display area, a projection of the non-visual area on the glass cover plate falls within the non-display area.

The sensing area of the touch panel is defined by edges of the first conductive layer and the second conductive layer. The sensing area includes a visual area and a non-visual area located at an outer edge of the visual area. The visual area is aligned with the display area, and a projection of the visual area on the glass cover plate coincides with the display area. The non-visual area is aligned with the non-display area, and a projection of the non-visual area on the glass cover plate falls within the non-display area. Therefore the non-display area of the glass cover plate also has sensing features, which can enhance the user's experience.

These and other objects, advantages, purposes and features will become apparent upon review of the following specification in conjunction with the drawings.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is an exploded perspective view of an embodiment of a touch panel;

FIG. 2 is a top plan view of the touch panel of FIG. 1;

FIG. 3 is a cross-sectional view of the touch panel of FIG. 1;

FIG. 4 is an exploded perspective view of the touch panel of FIG. 1;

FIG. 5a through FIG. 5d are enlarged views showing multiple embodiments of the mesh cell of a first conductive layer and a second conductive layer;

FIG. 6 is top plan view of another embodiment of a touch panel;

FIG. 7 is a cross-sectional view of the touch panel of FIG. 6;

FIG. 8 is an exploded perspective view of the touch panel of FIG. 6;

FIG. 9 is a cross-sectional view of yet another embodiment of a touch panel;

FIG. 10 is an exploded perspective view of the touch panel of FIG. 9;

FIG. 11 is a cross-sectional view of yet another embodiment of a touch panel;

FIG. 12 is an exploded perspective view of the touch panel of FIG. 11;

FIG. 13 is a cross-sectional view of yet another embodiment of a touch panel;

FIG. 14 is an exploded perspective view of the touch panel of FIG. 13;

FIG. 15 is a cross-sectional view of yet another embodiment of a touch panel;

FIG. 16 is an exploded perspective view of the touch panel of FIG. 15;

FIG. 17 is a cross-sectional view of yet another embodiment of a touch panel;

FIG. 18 is an exploded perspective view of the touch panel of FIG. 17; and

FIG. 19 is a cross-sectional view of yet another embodiment of a touch panel.

### DETAILED DESCRIPTION OF THE EMBODIMENTS

Reference will now be made to the drawings to describe, in detail, embodiments of the present touch panel. It should be noted that references to “an” or “one” embodiment in this disclosure are not necessarily to the same embodiment, and such references mean at least one.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

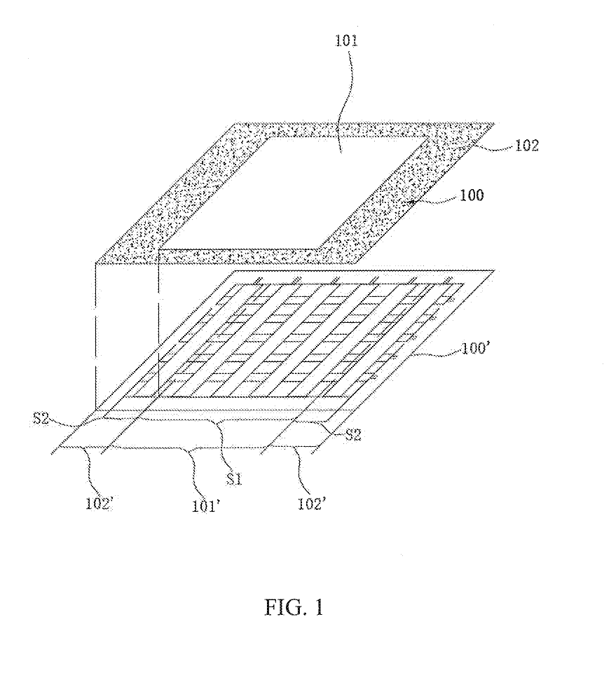

Referring to FIG. 1 to FIG. 3, an embodiment of a touch panel includes a glass cover plate 100 and a touch sensing module 200.

The glass cover plate 100 has a display area 101 and a non-display area 102 which is located at an outer edge of the display area 101 and surrounds the display area 101.

The glass cover plate 100 includes a display panel and an ink frame located at an edge of the display panel. The non-display area 102 is formed from the ink frame, and the display area 101 is defined as the area of the display panel not covered by the ink frame.

The glass cover plate 100 is made of calcium aluminosilicate glass or sodium glass. The glass cover plate 100 has a thickness of 0.3 mm to 1.2 mm, preferably 0.5 mm to 0.7 mm, which can ensure a fine light transmittance of the touch panel.

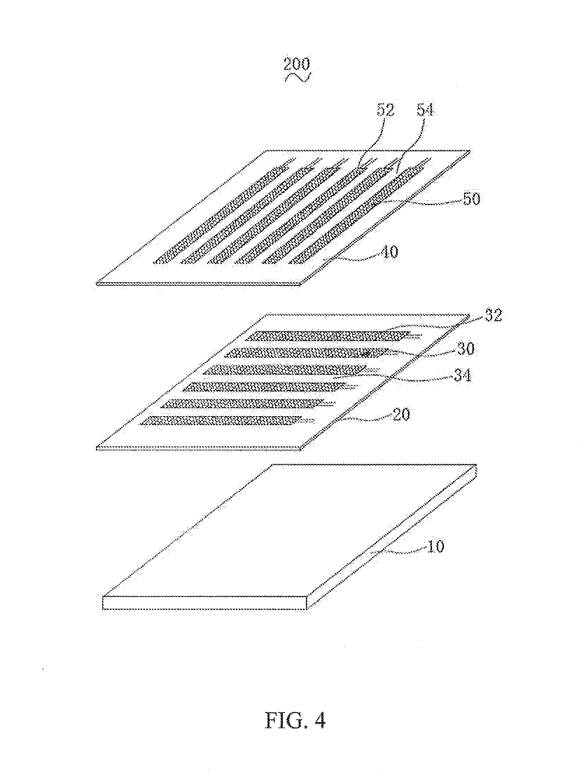

Referring also to FIG. 4, the touch sensing module 200 includes a first dielectric layer 20, a first conductive layer 30, a second dielectric layer 40, a second conductive layer 50, a first electrode trace 60, and a second electrode trace 70.

The first dielectric layer 20 is laminated on a surface of the glass cover plate 100. The first dielectric layer 20 is formed by coating and curing a thermosetting resin or a UV curable resin on the glass cover plate 100.

The first dielectric layer 20 has a preferable thickness of 1 μm to 10 μm, more preferably 2 μm to 5 μm, so as to obtain a better light transmittance, such that the first dielectric layer 20 will not affect the overall light transmittance of the touch sensing module 200.

The first dielectric layer 20 defines a meshed first groove 22 at a side thereof away from the glass cover plate 100. The first groove 22 is formed on the first dielectric layer 20 by using an imprinting mold. A depth-to-width ratio of the first groove 22 is greater than or equals to 1.

The first conductive layer 30 is grid-like and formed by a plurality of conductive wires intersected with each other. The first conductive layer 30 includes a plurality of first conductive strips 32 extending along a first direction. Two adjacent first conductive strips 32 form a gap 34 therebetween, therefore the plurality of first conductive strips 32 are spaced and are insulated from each other. The first conductive layer 30 is received in the first groove 22 so that it is embedded in the first dielectric layer 20. The thickness of the first conductive layer 30 is no greater than the depth of the first groove 22.

In the illustrated embodiment, the first direction is one coordinate direction of the Cartesian system, which is parallel to a longitude direction of the first dielectric layer 20 shown in FIG. 4.

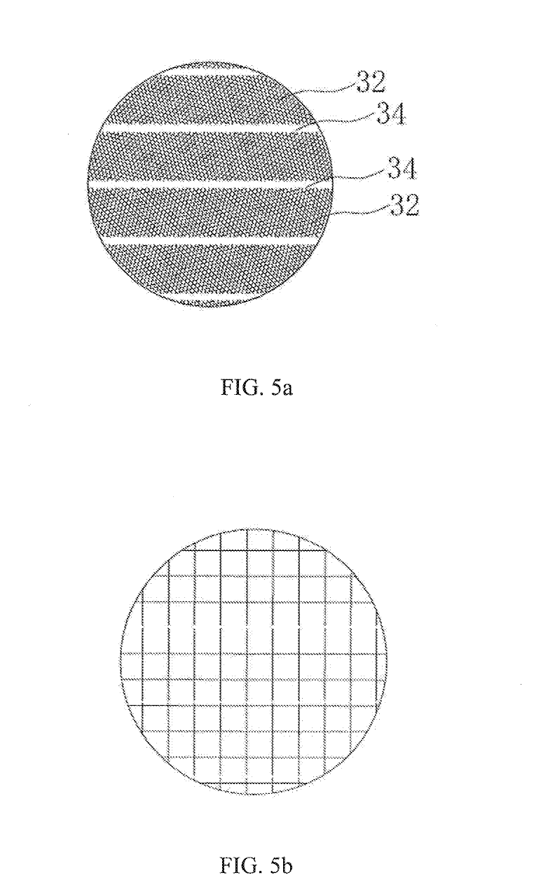

The first conductive strip 32 is a conductive mesh formed by conductive wires. Each first conductive strip 32 includes a plurality of mesh cells. The mesh cell may have a shape of square (see FIG. 5b), rhombus (see FIG. 5c), regular hexagonal (see FIG. 5a) or a random shape (see FIG. 5d). In addition, the conductive metal mesh is divided into a plurality of insulated conductive patterns, as shown in FIG. 5b to FIG. 5d.

The conductive wires are formed by curing conductive material filled in the first groove 22. The conductive material may be metal or indium tin oxide (ITO). Compared with the conventional coating-patterning-etching process of ITO, the method of filling conductive material in the first groove 22 to form the first conductive layer can greatly save raw materials. In addition, the process of patterning is performed by imprinting mold, such that the patterned first groove 22 can be one-time imprinted without multiple developing-exposing-etching processes, thus simplifying the procedure and reducing the cost of the touch panel.

Preferably, the conductive material is a metal material selected from the group consisting of gold (Au), silver (Ag), copper (Cu), nickel (Ni), molybdenum (Mo), aluminum (Al), and zinc (Zn), or alloy thereof.

Compared with the expensive ITO, the prices of the gold (Au), silver (Ag), copper (Cu), nickel (Ni), molybdenum (Mo), aluminum (Al), and zinc (Zn) are low, which can reduce the cost of the touch panel and meet the conductivity requirement. Furthermore, the flexible metal wire is not tend to be cracked, such that the conductivity of the first conductive layer 30 is stable, thereby improving the stability of the touch panel.

Since the metal wire is opaque, in order to increase the transparent area, the width of metal wire should be reduced, and the distance between two adjacent metal wires should be increased, thereby increasing the light transmittance of the touch sensing module 200.

Preferably, the conductive wires have a width ranged from 0.2 μm to 5 μm. The less the width of the metal wire, the better transmittance. However, the resistance of the first conductive layer 30 increases as the width of the metal wire is reduced. Considering both of the light transmittance and the resistance, the width of the metal wire is preferably in a range from 0.5 μm to 2 μm, and the distance between two adjacent metal wires is from 50 μm to 500 μm.

The first conductive layer 30 has a thickness of 1 μm to 10 μm, preferably 2 μm to 5 μm. The metal wire with a thickness of 2 μm to 5 μm can have an excellent electrical properties and transparency, so that the first conductive layer 30 has an increasing conductivity and a higher transparency.

The second dielectric layer 40 is laminated on the first dielectric layer 20. The second dielectric layer 40 is formed by coating and curing a thermosetting resin or a UV curable resin on the first dielectric layer 20.

Preferably, the second dielectric layer 40 has a preferable thickness of 1 μm to 10 μm, more preferably 2 μm to 5 μm, so as to achieve a better light transmittance, such that the second dielectric layer 40 will not affect the overall light transmittance of the touch sensing module 200.

The second dielectric layer 40 defines a meshed second groove 42 at a side thereof away from the glass cover plate 100. The second groove 42 is formed on the second dielectric layer 40 by using an imprinting mold. A depth-to-width ratio of the second groove 42 is greater than or equals to 1.

The second conductive layer 50 is grid-like and formed by a plurality of conductive wires intersected with each other. The second conductive layer 50 includes a plurality of second conductive strips 52 extending along a second direction. Two adjacent second conductive strips 52 form a gap 54 therebetween, therefore the plurality of second conductive strips 52 are spaced and are insulated from each other. The second conductive layer 50 is received in the second groove 42, so that it is embedded in the second dielectric layer 40. The thickness of the second conductive layer 50 is no greater than the depth of the second groove 42, so as to ensure that the second conductive layer 50 and the first conductive layer 30 are insulated.

In the illustrated embodiment, the second direction is the other coordinate direction of the Cartesian system, which is perpendicular to the first direction. When the first direction is a longitude direction of the first dielectric layer 20, the second direction can be parallel to a width direction of the second dielectric layer 40. While the Cartesian system is given as an example, other systems, such oblique coordinate system or polar coordinate system, can be implemented.

The second conductive strip 52 is a conductive mesh formed by conductive wires. Similar to the first conductive strip 32, each second conductive strip 52 includes a plurality of mesh cells, which may have a shape of square, rhombus, regular hexagonal or a random shape.

The conductive wires are formed by curing conductive material filled in the second groove 42. The conductive material may be metal or indium tin oxide (ITO). This manufacturing method can simplify the procedure and reduce the cost of the touch panel.

Preferably, the conductive material is a metal material selected from the group consisting of gold (Au), silver (Ag), copper (Cu), nickel (Ni), molybdenum (Mo), aluminum (Al), and zinc (Zn), or alloy thereof. Using metal to form the second conductive layer 50 can reduce the cost of the touch panel and enhance the touch stability.

The conductive wires have a width of from 0.2 μm to 5 μm, preferably in a range from 0.5 μm to 2 μm. The distance between two adjacent metal wires is from 50 μm to 500 μm.

The first conductive layer 30 and the second conductive layer 50 are embedded in the first dielectric layer 20 and the second dielectric layer 40, respectively, such that the first conductive layer 30 and the second conductive layer 50 are laminated on the glass cover plate 100 along a thickness direction thereof.

Projections of the first conductive strips 32 on a plane where the second conductive strips 52 are located intersect the second conductive strips 52 to form a capacitance structure without using conductive bridges, thus simplifying the procedure.

Preferably, the projections of the conductive wires of the first conductive layer 30 on a plane located by the second conductive layer 50 coincides with the conductive wires of the second conductive layer 50, so as to minimize the occupied area of the conductive wires of the first conductive layer 30 and the second conductive layer 50 on the visual area, thus increasing the light transmittance.

The touch sensing module 200 further includes a sensing area defined by edges of the first conductive layer 30 and the second conductive layer 50.

Referring to FIG. 1, the sensing area includes a visual area S1 and a non-visual area S2 located at an outer edge of the visual area S1. The glass cover plate 100 includes a frame 100′, an area 101′ corresponding to the display area 101, and an area 102′ corresponding to the non-display area 102. As can be seen from FIG. 1, the visual area S1 is aligned with the display area 101 of the glass cover plate 100, and a projection of the visual area S1 on the glass cover plate 100 coincides with the display area 101. The non-visual area S2 is aligned with the non-display area 102, and a projection of the non-visual area S2 on the glass cover plate 100 falls within the non-display area 102.

The visual area S1 and the non-visual area S2 both have sensing features, such that the non-display area 102 and the area corresponding to non-visual area S2 of the glass cover plate 100 also have sensing features, which can enhance the user's experience. For example, the user can perform operations such as flipping, adjusting the volume, locking operating interface via touching the non-display area 102 of the glass cover plate 100.

In the illustrated embodiment, the number of the non-visual area S2 is two, and the two non-visual areas S2 are located at opposite sides of the visual area S1, such that both non-visual areas S2 located at opposite sides of the display area 101 can have sensing features.

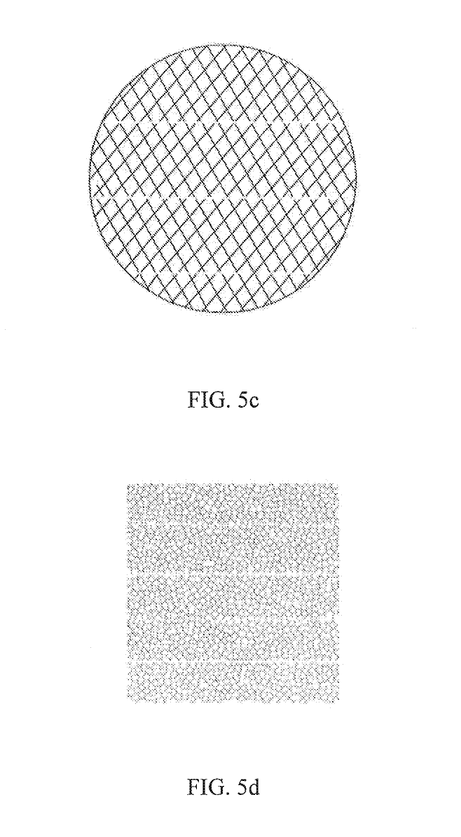

Referring to FIG. 6, in an alternative embodiment, there may be only one non-visual area S2 located at one side of the visual area S1.

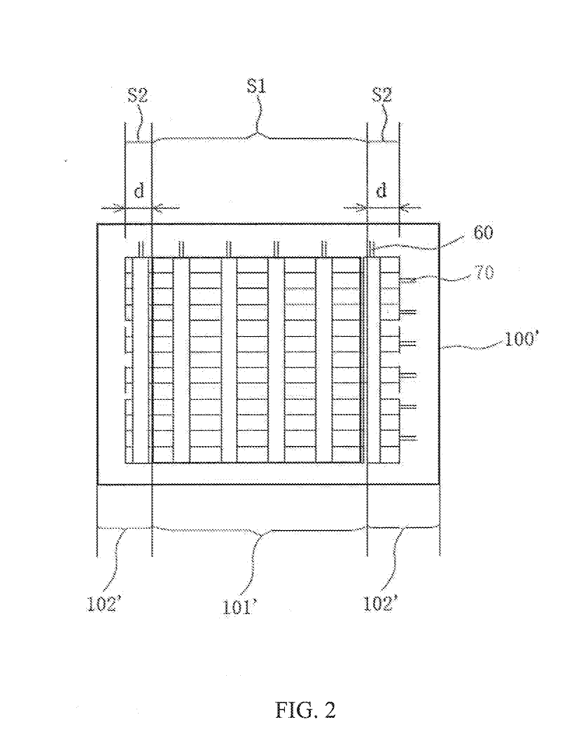

As can be seen from FIG. 2 and FIG. 6, the non-visual area S2 has a strip-like shape with a width of d.

In order to facilitating the touch panel, d is greater than 0.5 mm. In addition, d is no greater than the width of the non-display area 102, more preferably, d is no less than 1 mm.

The first electrode trace 60 and the second electrode trace 70 are embedded in the first dielectric layer 20 and the second dielectric layer 40, respectively, and the first electrode trace 60 and the second electrode trace 70 are electrically coupled to the first conductive layer 30 and the second conductive layer 50, respectively. The first electrode trace 60 and the second electrode trace 70 are aligned with the non-display area 102 of the glass cover plate 100.

In the forgoing touch panel, the sensing area of the touch panel is defined by edges of the first conductive layer 30 and the second conductive layer 50. The sensing area includes a visual area S1 and a non-visual area S2 located at an outer edge of the visual area S1. The visual area S1 is aligned with the display area 101, and the projection of the visual area S1 on the glass cover plate 100 coincides with the display area 101. The non-visual area S2 is aligned with the non-display area 102, and the projection of the non-visual area S2 on the glass cover plate 100 falls within the non-display area 102, therefore the non-display area 102 of the glass cover plate 100 also has sensing features, which can enhance the user's experience.

The first conductive layer 30 and the second conductive layer 50 of the touch sensing module 200 are formed by filling conductive materials in the first groove 22 and the second groove 42, no etching process and bridge structure are needed during the fabrication, such that the cost of the raw materials is saved and the procedures are simplified. The metal conductive material can further reduce the price of the touch panel and increase the stability.

The touch panel described above has a OGS (One Glass Solution) structure, the thickness thereof is a sum of the thicknesses of the glass cover plate 100, the first dielectric layer 20, and the second dielectric layer 40, thus it is thinner and favorable for the electronic device to develop in an thinner and lighter direction.

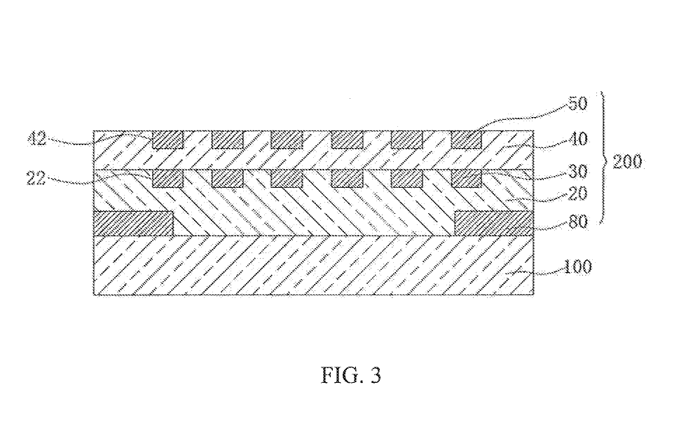

Referring to FIG. 3, preferably, the touch panel further includes a shielding layer 80. The shielding layer 80 has the same shape as the non-display area 102, and a projection of the shielding layer 80 on the glass cover plate 100 coincides with the non-display area 102.

The shielding layer 80 is positioned between the glass cover plate 100 and the touch sensing module 200. In the illustrated embodiment, the shielding layer 80 is formed by shielding ink. In alternative embodiments, the shielding layer 80 may be made of chromium (Cr). The shielding layer 80 can shield the structures and components under the glass cover plate 100 which are not necessary to be exposed, such as the frame circuit, so as to improve the appearance of the touch panel. It is to be understood that, in alternative embodiments, the shielding layer 80 can be omitted, as long as the structures and components are already covered by other structures.

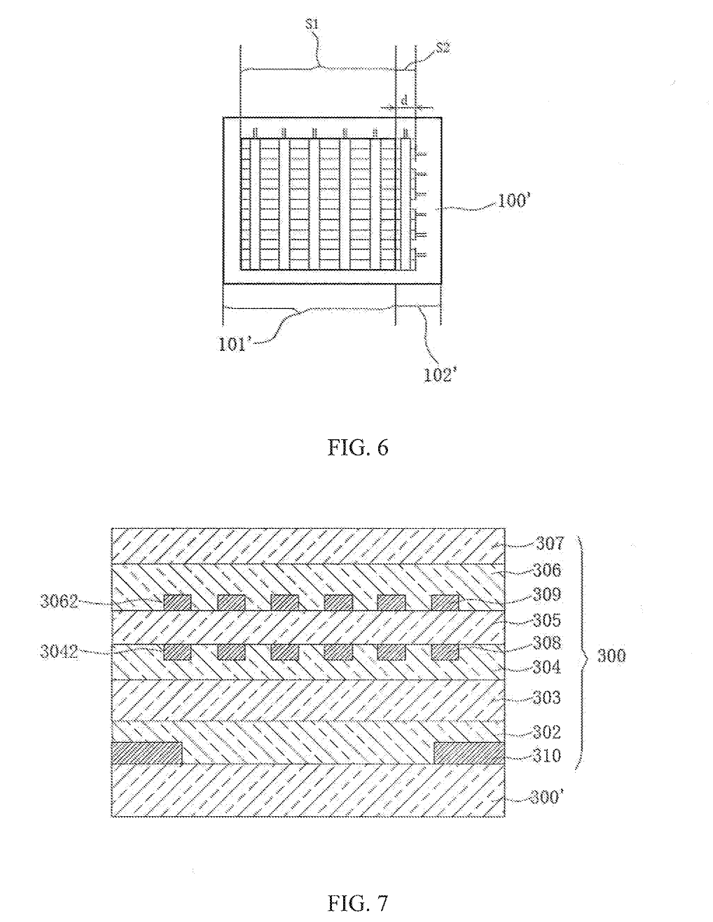

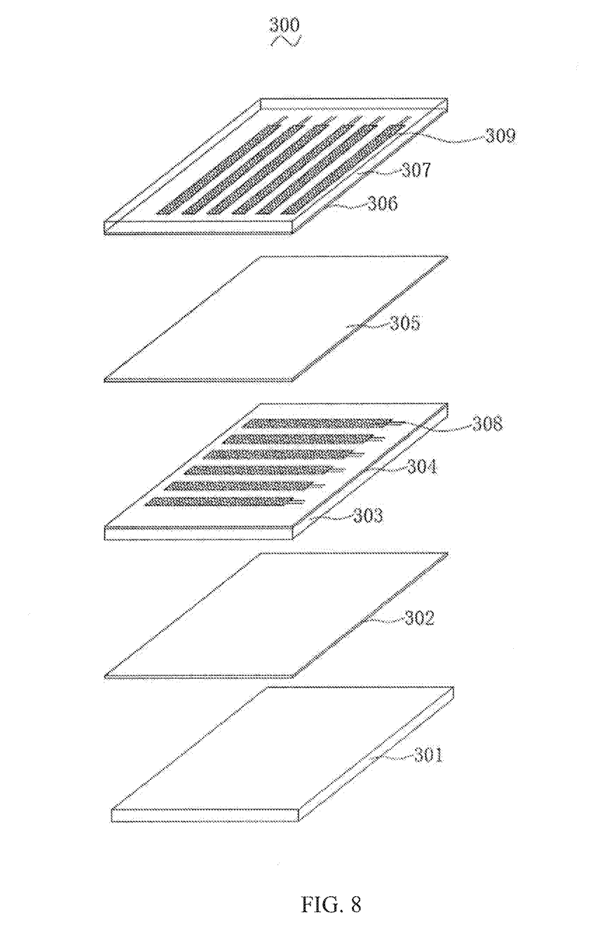

Referring to FIG. 7 and FIG. 8, another embodiment of the touch panel includes a glass cover plate 300′ and a touch sensing module 300.

The glass cover plate 300′ has a display area (not shown) and a non-display area (not shown) which is located at an outer edge of the display area and surrounds it. The glass cover plate 300′ has a thickness of 0.3 mm to 1.2 mm, preferably 0.5 mm to 0.7 mm, which can ensure a fine light transmittance of the touch panel.

The touch sensing module 300 includes a first adhesive layer 302, a first transparent substrate 303, a first dielectric layer 304, a second adhesive layer 305, a second dielectric layer 306, and a second transparent substrate 307, which are laminated on the glass cover plate 300′ in that order.

The touch sensing module 300 further includes a first conductive layer 308 and a second conductive layer 309 embedded in the first dielectric layer 304 and the second dielectric layer 306, respectively. The touch sensing module 300 further includes a first electrode trace and a second electrode trace embedded in the first dielectric layer 304 and the second dielectric layer 306, respectively. The first electrode trace and the second electrode trace are electrically coupled to the first conductive layer 308 and the second conductive layer 309, respectively. The first electrode trace and the second electrode trace are corresponding to the non-display area of the glass cover plate 300′.

The first adhesive layer 302 can be made of OCA (Optically Clear Adhesive), such as optical grade polyacrylic acid resins, liquid glue, etc. In order to avoid the first conductive layer 308 and the second conductive layer 309 from being etched, the OCA is an acid-free or low-acid OCA.

The first adhesive layer 302 is used to bond the glass cover plate 300′ to the first transparent substrate 303. In order to ensure the light transmittance of the touch sensing module 300, the thickness of the first adhesive layer 302 preferably ranges from 50 μm to 200 μm.

The first transparent substrate 303 is a glass substrate or flexible transparent substrate, such as polyethylene terephthalate substrate. The thickness of the first transparent substrate 303 preferably ranges from 0.025 mm to 0.3 mm.

The first dielectric layer 304 is formed by coating and curing a thermosetting resin or a UV curable resin on the first transparent substrate 303. The first dielectric layer 304 has a preferable thickness of 1 μm to 10 μm, more preferably 2 μm to 5 μm. The first dielectric layer 304 defines a meshed first groove 3042 at a side thereof away from the first transparent substrate 303. The first groove 3042 is formed on the first dielectric layer 304 by using an imprinting mold. A depth-to-width ratio of the first groove 3042 is greater than or equals to 1.

The second adhesive layer 305 can be made of OCA, such as optical grade polyacrylic acid resins, liquid glue, etc. The second adhesive layer 305 is used to bond the first dielectric layer 304 to the second dielectric layer 306. The thickness of the first adhesive layer 305 preferably ranges from 25 μm to 100 μm.

The second dielectric layer 306 has the same material and the thickness as that of the first dielectric layer 304. The second dielectric layer 306 defines a second groove 3062 on a side thereof adjacent to the second adhesive layer 305. The second groove 3062 is formed on the second dielectric layer 306 by using an imprinting mold. A depth-to-width ratio of the second groove 3062 is greater than or equals to 1.

The second transparent substrate 307 is a glass substrate or a flexible transparent substrate, such as polyethylene terephthalate substrate. The thickness of the second transparent substrate 307 preferably ranges from 0.025 mm to 0.3 mm.

The first conductive layer 308 and the second conductive layer 309 have the same structure as the first conductive layer 30 and the second conductive layer 50 of the forgoing embodiments. The first conductive layer 308 includes a plurality of first conductive strips extending along a first direction. The second conductive layer 309 includes a plurality of second conductive strips extending along a second direction. The first conductive layer 308 is received in the first groove 3042 and is embedded in the first dielectric layer 304, and the second conductive layer 309 is received in the second groove 3062 and embedded in the second dielectric layer 306. The thickness of the first conductive layer 308 is no greater than the depth of the first groove 3042, and the thickness of the second conductive layer 309 is no greater than the depth of the second groove 3062, so as to ensure that the first conductive layer 308 and the second conductive layer 309 are insulated from each other.

The first dielectric layer 304 and the second dielectric layer 306 can effectively protect the first conductive layer 308 and the second conductive layer 309 from being damaged during the manufacturing process. In addition, the first dielectric layer 304 and the second dielectric layer 306 are positioned in the first transparent substrate 303 and the second transparent substrate 307, respectively, so as to further protect the first conductive layer 308 and the second conductive layer 309, thus avoiding conductive wires which form the first conductive layer 308 and the second conductive layer 309 from being damaged to affect the conductivity and the touch performance of the touch sensing module 300.

Projections of the first conductive strips on a plane where the second conductive strips are located intersect the second conductive strips to form a mutual capacitance without using conductive bridges, thus simplifying the procedure.

Preferably, the projections of the conductive wires of the first conductive layer 308 on a plane located by the second conductive layer 309 coincides with the conductive wires of the second conductive layer 309, so as to minimize the occupied area of the conductive wires of the first conductive layer 308 and the second conductive layer 309 on the visual area, thus increasing the light transmittance.

The thickness of the first conductive layer 308 and the second conductive layer 309 is in a range from 1 μm to 10 μm, preferably from 2 μm to 5 μm.

The sensing area of the touch sensing module 300 is formed by the edges of the first conductive layer 308 and the second conductive layer 309.

The sensing area includes a visual area and a non-visual area located at an outer edge of the visual area. The visual area is aligned with the display area of the glass cover plate 300′, and a projection of the visual area on the glass cover plate 300′ coincides with the display area. The non-visual area is aligned with the non-display area of the glass cover plate 300′, and a projection of the non-visual area on the glass cover plate 300′ falls within the non-display area. Therefore the non-display area of the glass cover plate 300′ also has sensing features, which can enhance the user's experience. For example, the user can perform operations such as flipping, adjusting the volume, locking operating interface via touching the non-display area of the glass cover plate 300′.

In the illustrated embodiment, the number of the non-visual area is one, and the non-visual area is located at a side of the visual area. In alternative embodiment, the number of the non-visual area is two, and the two non-visual areas are located at opposite sides of the visual area.

The non-visual area has a strip-like shape with a width of d. In order to facilitating the touch, d is greater than 0.5 mm. In addition, d is no greater than the width of the non-display area 102, more preferably, d is no less than 1 mm.

The sensing area of the touch panel is defined by edges of the first conductive layer 308 and the second conductive layer 309. The sensing area includes a visual area and a non-visual area located at an outer edge of the visual area. The visual area is aligned with the display area, and the projection of the visual area on the glass cover plate 300′ coincides with the display area. The non-visual area is aligned with the non-display area, and the projection of the non-visual area on the glass cover plate 300′ falls within the non-display area, therefore the non-display area also has sensing features, which can enhance the user's experience.

The first conductive layer 308 and the second conductive layer 309 of the touch sensing module 300 are formed by filling conductive materials in the first groove 3042 and the second groove 3062, no etching process and bridge structure are needed during the fabrication, such that the cost of the raw materials is saved and the procedures are simplified. The metal conductive material can further reduce the price of the touch panel and increase the stability.

The described touch panel has a GFF (Glass-Film-Film) structure, which supports multi-touch and has a lower cost. In the illustrated embodiment, the first conductive layer 308 and the second conductive layer 309 are face-to-face configured. It is to be understood that, in alternative embodiments, the conductive layer 308 and the second conductive layer 309 can be configured back-to-back or on the same side.

Referring to FIG. 7, the touch panel further includes a shielding layer 310. The shielding layer 310 has the same shape as the non-display area, and a projection of the shielding layer 310 on the glass cover plate 300′ coincides with the non-display area.

The shielding layer 310 is positioned between the glass cover plate 300′ and the touch sensing module 300. In the illustrated embodiment, the shielding layer 310 is formed by shielding ink. In alternative embodiment, the shielding layer 310 may be made of chromium (Cr). The shielding layer 310 can shield the structures and components under the glass cover plate 300′ which are not necessary to be exposed, such as the frame circuit, so as to improve the appearance of the touch panel. It is to be understood that, in alternative embodiments, the shielding layer 310 can be omitted, as long as the structures and components are already covered by other structures.

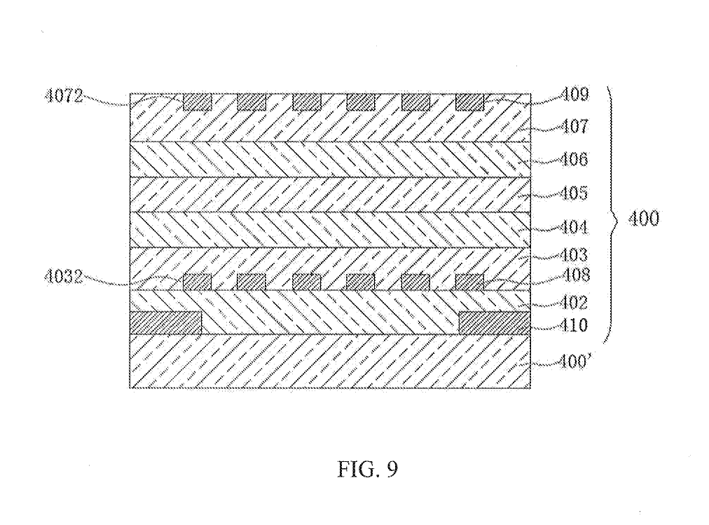

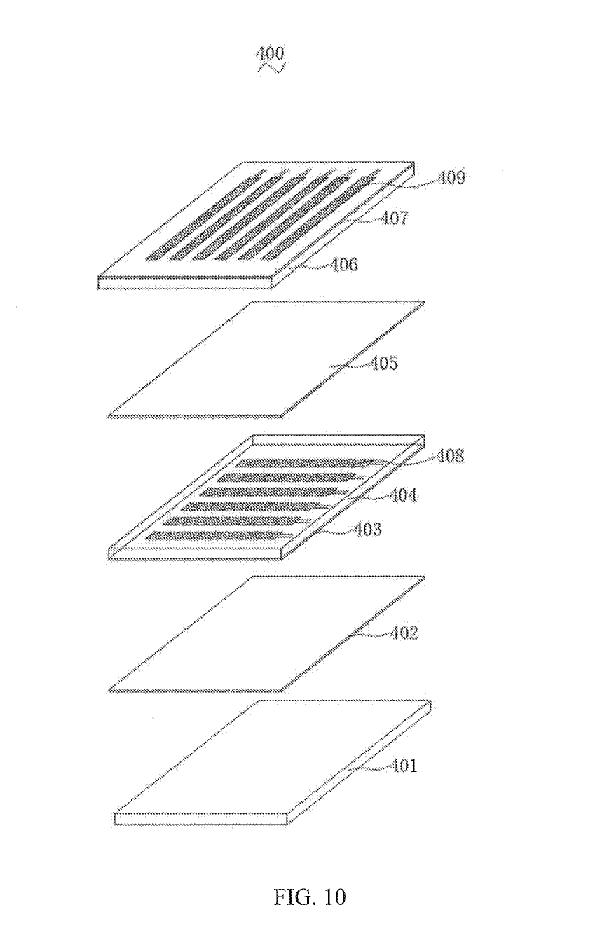

Referring to FIG. 9 and FIG. 10, another embodiment of the touch panel includes a glass cover plate 400′ and a touch sensing module 400.

The glass cover plate 400′ has a display area (not shown) and a non-display area (not shown) which is located at an outer edge of the display area and surrounds it. The glass cover plate 400′ can be an aluminosilicate glass plate or sodium calcium glass plate. The glass cover plate 400′ has a thickness of 0.3 mm to 1.2 mm, preferably 0.5 mm to 0.7 mm, which can ensure a fine light transmittance of the touch panel.

The touch sensing module 400 includes a first adhesive layer 402, a first dielectric layer 403, a first transparent substrate 404, a second adhesive layer 405, a second transparent substrate 406, and a second dielectric layer 407, which are laminated on the glass cover plate 400′ in that order.

The touch sensing module 400 further includes a first conductive layer 408 and a second conductive layer 409 embedded in the first dielectric layer 403 and the second dielectric layer 407, respectively. The touch sensing module 400 further includes a first electrode trace and a second electrode trace embedded in the first dielectric layer 403 and the second dielectric layer 407, respectively. The first electrode trace and the second electrode trace are electrically coupled to the first conductive layer 408 and the second conductive layer 409, respectively. The first electrode trace and the second electrode trace are corresponding to the non-display area of the glass cover plate 400′.

The first adhesive layer 402, the first transparent substrate 404, the second adhesive layer 405, and the second transparent substrate 406 have the same structure and materials as that of the first adhesive layer 302, the first transparent substrate 303, the second adhesive layer 305, and the second transparent substrate 307 of the touch sensing module 300.

The first dielectric layer 403 and the second dielectric layer 407 have the same thicknesses and materials as that of the first dielectric layer 304 and the second dielectric layer 306 of the touch sensing module 300.

The first dielectric layer 403 defines a meshed first groove 4032 at a side thereof adjacent to the first adhesive layer 402. The first groove 4032 is formed on the first dielectric layer 403 by using an imprinting mold. A depth-to-width ratio of the first groove 4032 is greater than or equals to 1. The second dielectric layer 407 defines a second groove 4072 on a side thereof away from the second transparent substrate 406. The second groove 4072 is formed on the second dielectric layer 407 by using an imprinting mold. A depth-to-width ratio of the second groove 4072 is greater than or equals to 1.

The first conductive layer 408 and the second conductive layer 409 have the same structure as the first conductive layer 30 and the second conductive layer 50 of the forgoing embodiments. The first conductive layer 408 includes a plurality of first conductive strips extending along a first direction. The second conductive layer 409 includes a plurality of second conductive strips extending along a second direction. The first conductive layer 408 is received in the first groove 4032 and is embedded in the first dielectric layer 403, and the second conductive layer 409 is received in the second groove 4072 and embedded in the second dielectric layer 407. The thickness of the first conductive layer 408 is no greater than the depth of the first groove 4032, and the thickness of the second conductive layer 409 is no greater than the depth of the second groove 4072, so as to ensure that the first conductive layer 408 and the second conductive layer 409 are insulated from each other.

Projections of the first conductive strips on a plane where the second conductive strips are located intersect the second conductive strips to form a mutual capacitance without using conductive bridges, thus simplifying the procedure.

Preferably, the projections of the conductive wires of the first conductive layer 408 on a plane located by the second conductive layer 409 coincides with the conductive wires of the second conductive layer 409, so as to minimize the occupied area of the conductive wires of the first conductive layer 408 and the second conductive layer 409 on the visual area, thus increasing the light transmittance.

The thickness of the first conductive layer 408 and the second conductive layer 409 is in a range of from 1 μm to 10 μm, preferably from 2 μm to 5 μm.

The sensing area of the touch sensing module 400 is defined by the edges of the first conductive layer 408 and the second conductive layer 409.

The sensing area includes a visual area and a non-visual area located at an outer edge of the visual area. The visual area is aligned with the display area of the glass cover plate 400′, and a projection of the visual area on the glass cover plate 400′ coincides with the display area. The non-visual area is aligned with the non-display area of the glass cover plate 400′, and a projection of the non-visual area on the glass cover plate 400′ falls within the non-display area. Therefore the non-display area of the glass cover plate 400′ also has sensing features, which can enhance the user's experience. For example, the user can perform operations such as flipping, adjusting the volume, locking operating interface via touching the non-display area of the glass cover plate 400′.

In the illustrated embodiment, the number of the non-visual area is one, and the non-visual area is located at a side of the visual area. In alternative embodiment, the number of the non-visual area is two, and the two non-visual areas are located at opposite sides of the visual area.

The non-visual area has a strip-like shape with a width of d. In order to facilitating the touch, d is greater than 0.5 mm. In addition, d is no greater than the width of the non-display area, more preferably, d is no less than 1 mm.

The sensing area of the touch panel is defined by edges of the first conductive layer 408 and the second conductive layer 409. The sensing area includes a visual area and a non-visual area located at an outer edge of the visual area. The visual area is aligned with the display area, and the projection of the visual area on the glass cover plate 400′ coincides with the display area. The non-visual area is aligned with the non-display area, and the projection of the non-visual area on the glass cover plate 400′ falls within the non-display area, therefore the non-display area also has sensing features, which can enhance the user's experience.

The first conductive layer 408 and the second conductive layer 409 of the touch sensing module 400 are formed by filling conductive materials in the first groove 4032 and the second groove 4072, no etching process and bridge structure are needed during the fabrication, such that the cost of the raw materials is saved and the procedures are simplified. The metal conductive material can further reduce the price of the touch panel and increase the stability.

The described touch panel has a GFF (Glass-Film-Film) structure, which supports multi-touch and has a lower cost. In the illustrated embodiment, the first conductive layer 408 and the second conductive layer 409 are back-to-back configured.

Referring to FIG. 9, the touch panel further includes a shielding layer 410. The shielding layer 410 has the same shape as the non-display area, and a projection of the shielding layer 410 on the glass cover plate 400′ coincides with the non-display area.

The shielding layer 410 is positioned between the glass cover plate 400′ and the touch sensing module 400. In the illustrated embodiment, the shielding layer 410 is formed by shielding ink. In alternative embodiment, the shielding layer 410 may be made of chromium (Cr). The shielding layer 410 can shield the structures and components under the glass cover plate 400′ which are not necessary to be exposed, such as the frame circuit, so as to improve the appearance of the touch panel. It is to be understood that, in alternative embodiments, the shielding layer 410 can be omitted, as long as the structures and components are already covered by other structures.

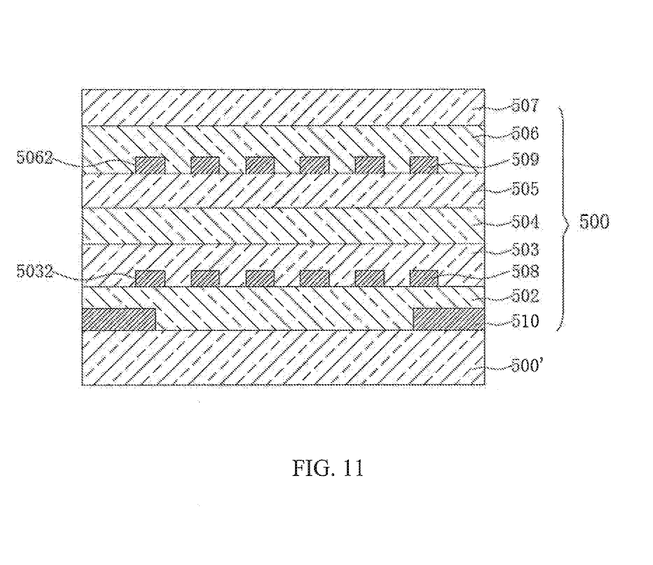

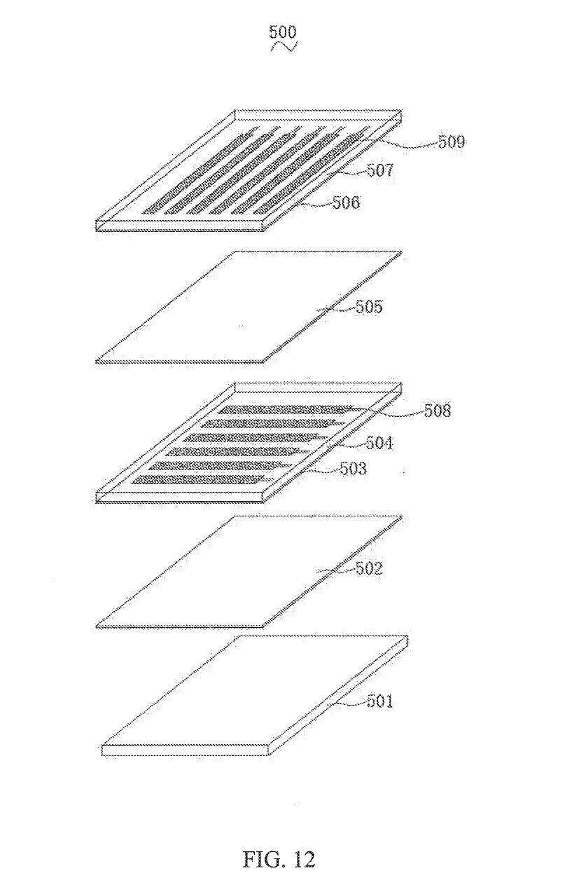

Referring to FIG. 11 and FIG. 12, another embodiment of the touch panel includes a glass cover plate 500′ and a touch sensing module 500.

The glass cover plate 500′ has a display area (not shown) and a non-display area (not shown) which is located at an outer edge of the display area and surrounds it. The glass cover plate 500′ can be an aluminosilicate glass plate or sodium calcium glass plate. The glass cover plate 500′ has a thickness of 0.3 mm to 1.2 mm, preferably 0.5 mm to 0.7 mm, which can ensure a fine light transmittance of the touch panel.

The touch sensing module 500 includes a first adhesive layer 502, a first dielectric layer 503, a first transparent substrate 504, a second adhesive layer 505, a second dielectric layer 506, a second transparent substrate 507, which are laminated on the glass cover plate 500′ in that order.

The touch sensing module 500 further includes a first conductive layer 508 and a second conductive layer 509 embedded in the first dielectric layer 503 and the second dielectric layer 506, respectively. The touch sensing module 500 further includes a first electrode trace and a second electrode trace embedded in the first dielectric layer 503 and the second dielectric layer 506, respectively. The first electrode trace and the second electrode trace are electrically coupled to the first conductive layer 508 and the second conductive layer 509, respectively. The first electrode trace and the second electrode trace are corresponding to the non-display area of the glass cover plate 500′.

The first adhesive layer 502, the first transparent substrate 504, the second adhesive layer 505, and the second transparent substrate 507 have the same structure and materials as that of the first adhesive layer 302, the first transparent substrate 303, the second adhesive layer 305, and the second transparent substrate 307 of the touch sensing module 300.

The first dielectric layer 503 and the second dielectric layer 506 have the same thicknesses and materials as that of the first dielectric layer 304 and the second dielectric layer 306 of the touch sensing module 300.

The first dielectric layer 503 defines a meshed first groove 5032 at a side thereof adjacent to the first adhesive layer 502. The first groove 5032 is formed on the first dielectric layer 503 by using an imprinting mold. A depth-to-width ratio of the first groove 5032 is greater than or equals to 1. The second dielectric layer 506 defines a second groove 5062 on a side thereof adjacent to the second adhesive layer 505. The second groove 5062 is formed on the second dielectric layer 506 by using an imprinting mold. A depth-to-width ratio of the second groove 5062 is greater than or equals to 1.

The first conductive layer 508 and the second conductive layer 509 have the same structure as the first conductive layer 30 and the second conductive layer 50 of the forgoing embodiments. The first conductive layer 508 includes a plurality of first conductive strips extending along a first direction. The second conductive layer 509 includes a plurality of second conductive strips extending along a second direction. The first conductive layer 508 is received in the first groove 5032 and is embedded in the first dielectric layer 503, and the second conductive layer 509 is received in the second groove 5062 and embedded in the second dielectric layer 506. The thickness of the first conductive layer 508 is no greater than the depth of the first groove 5032, and the thickness of the second conductive layer 509 is no greater than the depth of the second groove 5052, so as to ensure that the first conductive layer 508 and the second conductive layer 509 are insulated from each other.

Projections of the first conductive strips on a plane where the second conductive strips are located intersect the second conductive strips to form a mutual capacitance without using conductive bridges, thus simplifying the procedure.

Preferably, the projections of the conductive wires of the first conductive layer 508 on a plane located by the second conductive layer 509 coincides with the conductive wires of the second conductive layer 509, so as to minimize the occupied area of the conductive wires of the first conductive layer 508 and the second conductive layer 509 on the visual area, thus increasing the light transmittance.

The thickness of the first conductive layer 508 and the second conductive layer 509 is in a range of from 1 μm to 10 μm, preferably from 2 μm to 5 μm.

The sensing area of the touch sensing module 500 is defined by the edges of the first conductive layer 508 and the second conductive layer 509.

The sensing area includes a visual area and a non-visual area located at an outer edge of the visual area. The visual area is aligned with the display area of the glass cover plate 500′, and a projection of the visual area on the glass cover plate 500′ coincides with the display area. The non-visual area is aligned with the non-display area of the glass cover plate 500′, and a projection of the non-visual area on the glass cover plate 500′ falls within the non-display area. Therefore the non-display area of the glass cover plate 500′ also has sensing features, which can enhance the user's experience. For example, the user can perform operations such as flipping, adjusting the volume, locking operating interface via touching the non-display area of the glass cover plate 500′.

In the illustrated embodiment, the number of the non-visual area is one, and the non-visual area is located at a side of the visual area. In alternative embodiment, the number of the non-visual area is two, and the two non-visual areas are located at opposite sides of the visual area.

The non-visual area has a strip-like shape with a width of d. In order to facilitating the touch, d is greater than 0.5 mm. In addition, d is no greater than the width of the non-display area, more preferably, d is no less than 1 mm.

The sensing area of the touch panel is defined by edges of the first conductive layer 508 and the second conductive layer 509. The sensing area includes a visual area and a non-visual area located at an outer edge of the visual area. The visual area is aligned with the display area, and the projection of the visual area on the glass cover plate 500′ coincides with the display area. The non-visual area is aligned with the non-display area, and the projection of the non-visual area on the glass cover plate 500′ falls within the non-display area, therefore the non-display area also has sensing features, which can enhance the user's experience.

The first conductive layer 508 and the second conductive layer 509 of the touch sensing module 500 are formed by filling conductive materials in the first groove 5032 and the second groove 5062, no etching process and bridge structure are needed during the fabrication, such that the cost of the raw materials is saved and the procedures are simplified. The metal conductive material can further reduce the price of the touch panel and increase the stability.

The described touch panel has a GFF (Glass-Film-Film) structure, which supports multi-touch and has a lower cost. In the illustrated embodiment, the first conductive layer 508 and the second conductive layer 509 are both formed on the lower side of the dielectric layers.

Referring to FIG. 11, the touch panel further includes a shielding layer 510. The shielding layer 510 has the same shape as the non-display area, and a projection of the shielding layer 510 on the glass cover plate 500′ coincides with the non-display area.

The shielding layer 510 is positioned between the glass cover plate 500′ and the touch sensing module 500. In the illustrated embodiment, the shielding layer 510 is formed by shielding ink. In alternative embodiment, the shielding layer 510 may be made of chromium (Cr). The shielding layer 510 can shield the structures and components under the glass cover plate 500′ which are not necessary to be exposed, such as the frame circuit, so as to improve the appearance of the touch panel. It is to be understood that, in alternative embodiments, the shielding layer 510 can be omitted, as long as the structures and components are already covered by other structures.

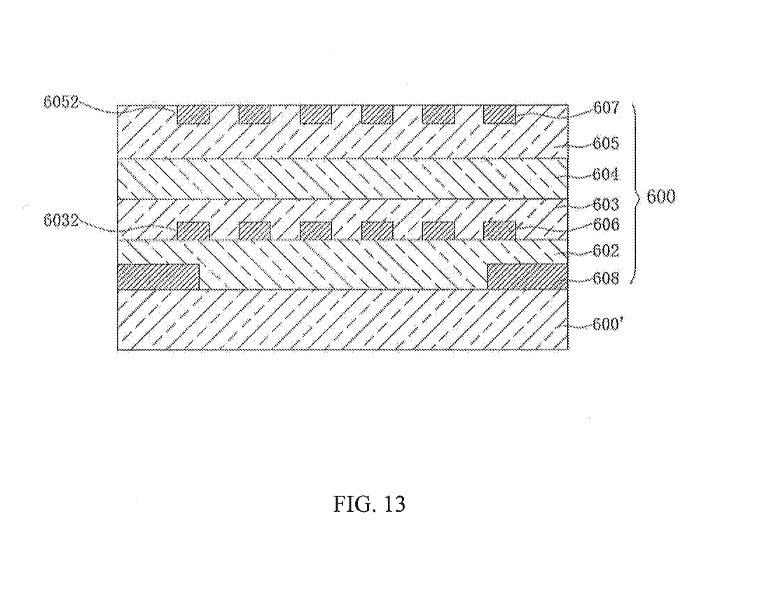

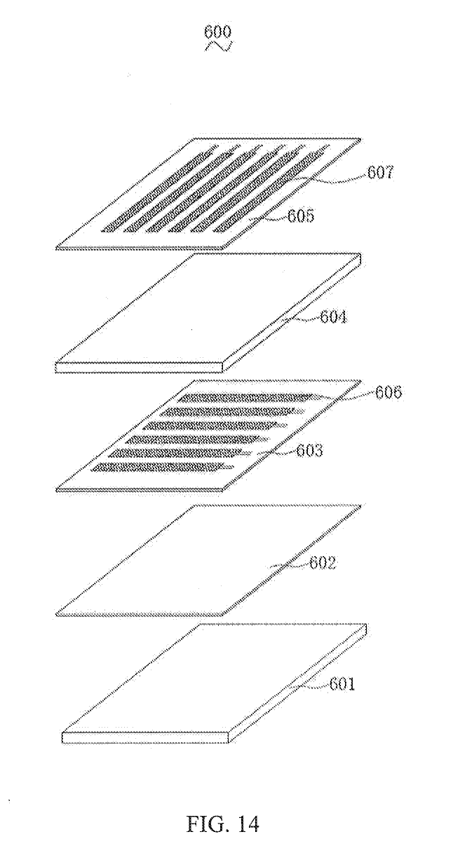

Referring to FIG. 13 and FIG. 14, another embodiment of the touch panel includes a glass cover plate 600′ and a touch sensing module 600.

The glass cover plate 600′ has a display area (not shown) and a non-display area (not shown) which is located at an outer edge of the display area and surrounds it. The glass cover plate 600′ can be an aluminosilicate glass plate or sodium calcium glass plate. The glass cover plate 600′ has a thickness of 0.3 mm to 1.2 mm, preferably 0.5 mm to 0.7 mm, which can ensure a fine light transmittance of the touch panel.

The touch sensing module 600 includes an adhesive layer 602, a first dielectric layer 603, a transparent substrate 604, and a second dielectric layer 605, which are laminated on the glass cover plate 600′ in that order. The touch sensing module 600 further includes a first conductive layer 606 and a second conductive layer 607 embedded in the first dielectric layer 603 and the second dielectric layer 605, respectively. The touch sensing module 600 further includes a first electrode trace and a second electrode trace embedded in the first dielectric layer 603 and the second dielectric layer 605, respectively. The first electrode trace and the second electrode trace are electrically coupled to the first conductive layer 606 and the second conductive layer 607, respectively. The first electrode trace and the second electrode trace are corresponding to the non-display area of the glass cover plate 600′.

The adhesive layer 602 and the transparent substrate 604 have the same structure and materials as that of the first adhesive layer 302 and the first transparent substrate 303 of the touch sensing module 300.

The first dielectric layer 603 and the second dielectric layer 605 have the same thicknesses and materials as that of the first dielectric layer 304 and the second dielectric layer 306 of the touch sensing module 300.

The first dielectric layer 603 defines a meshed first groove 6032 at a side thereof adjacent to the adhesive layer 602. The first groove 6032 is formed on the first dielectric layer 603 by using an imprinting mold. A depth-to-width ratio of the first groove 6032 is greater than or equals to 1. The second dielectric layer 605 defines a second groove 6052 on a side thereof away from the transparent substrate 604. The second groove 6052 is formed on the second dielectric layer 605 by using an imprinting mold. A depth-to-width ratio of the second groove 6052 is greater than or equals to 1.

The first conductive layer 606 and the second conductive layer 607 have the same structure as the first conductive layer 30 and the second conductive layer 50 of the forgoing embodiments. The first conductive layer 606 includes a plurality of first conductive strips extending along a first direction. The second conductive layer 607 includes a plurality of second conductive strips extending along a second direction. The first conductive layer 606 is received in the first groove 6032 and is embedded in the first dielectric layer 603, and the second conductive layer 607 is received in the second groove 6052 and embedded in the second dielectric layer 605. The thickness of the first conductive layer 606 is no greater than the depth of the first groove 6032, and the thickness of the second conductive layer 607 is no greater than the depth of the second groove 6052, so as to ensure that the first conductive layer 606 and the second conductive layer 607 are insulated from each other.

Projections of the first conductive strips on a plane where the second conductive strips are located intersect the second conductive strips to form a mutual capacitance without using conductive bridges, thus simplifying the procedure.

Preferably, the projections of the conductive wires of the first conductive layer 606 on a plane located by the second conductive layer 607 coincides with the conductive wires of the second conductive layer 607, so as to minimize the occupied area of the conductive wires of the first conductive layer 606 and the second conductive layer 607 on the visual area, thus increasing the light transmittance.

The thickness of the first conductive layer 606 and the second conductive layer 607 is in a range of from 1 μm to 10 μm, preferably from 2 μm to 5 μm.

The sensing area of the touch sensing module 600 is defined by the edges of the first conductive layer 606 and the second conductive layer 607.

The sensing area includes a visual area and a non-visual area located at an outer edge of the visual area. The visual area is aligned with the display area of the glass cover plate 600′, and a projection of the visual area on the glass cover plate 600′ coincides with the display area. The non-visual area is aligned with the non-display area of the glass cover plate 600′, and a projection of the non-visual area on the glass cover plate 600′ falls within the non-display area. Therefore the non-display area of the glass cover plate 600′ also has sensing features, which can enhance the user's experience. For example, the user can perform operations such as flipping, adjusting the volume, locking operating interface via touching the non-display area of the glass cover plate 600′.

In the illustrated embodiment, the number of the non-visual area is one, and the non-visual area is located at a side of the visual area. In alternative embodiment, the number of the non-visual area is two, and the two non-visual areas are located at opposite sides of the visual area.

The non-visual area has a strip-like shape with a width of d. In order to facilitating the touch, d is greater than 0.5 mm. In addition, d is no greater than the width of the non-display area, more preferably, d is no less than 1 mm.

The sensing area of the touch panel is defined by edges of the first conductive layer 606 and the second conductive layer 607. The sensing area includes a visual area and a non-visual area located at an outer edge of the visual area. The visual area is aligned with the display area, and the projection of the visual area on the glass cover plate 600′ coincides with the display area. The non-visual area is aligned with the non-display area, and the projection of the non-visual area on the glass cover plate 600′ falls within the non-display area, therefore the non-display area also has sensing features, which can enhance the user's experience.

The first conductive layer 606 and the second conductive layer 607 of the touch sensing module 600 are formed by filling conductive materials in the first groove 6032 and the second groove 6052, no etching process and bridge structure are needed during the fabrication, such that the cost of the raw materials is saved and the procedures are simplified. The metal conductive material can further reduce the price of the touch panel and increase the stability.

The described touch panel has a GF2 (glass/film dual ITO) structure, which can reduce a thickness of the film compared with the GFF structure. In addition, the both sides of the film can be patterned at the same time, thus simplifying the process.

Referring to FIG. 13, the touch panel further includes a shielding layer 608. The shielding layer 608 has the same shape as the non-display area, and a projection of the shielding layer 608 on the glass cover plate 600′ coincides with the non-display area.

The shielding layer 608 is positioned between the glass cover plate 600′ and the touch sensing module 600. In the illustrated embodiment, the shielding layer 608 is formed by shielding ink. In alternative embodiment, the shielding layer 608 may be made of chromium (Cr). The shielding layer 608 can shield the structures and components under the glass cover plate 600′ which are not necessary to be exposed, such as the frame circuit, so as to improve the appearance of the touch panel. It is to be understood that, in alternative embodiments, the shielding layer 608 can be omitted, as long as the structures and components are already covered by other structures.

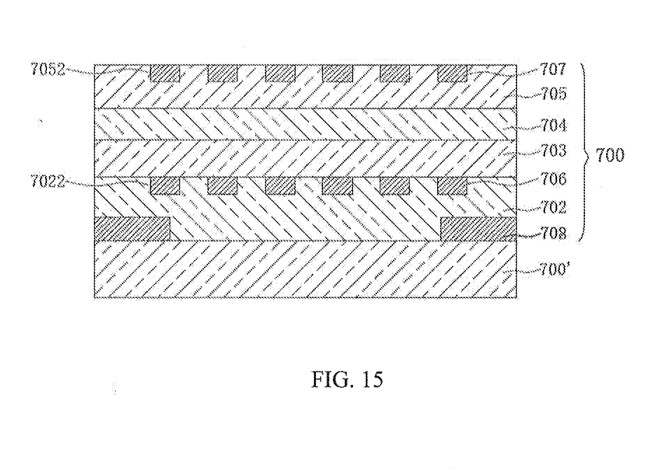

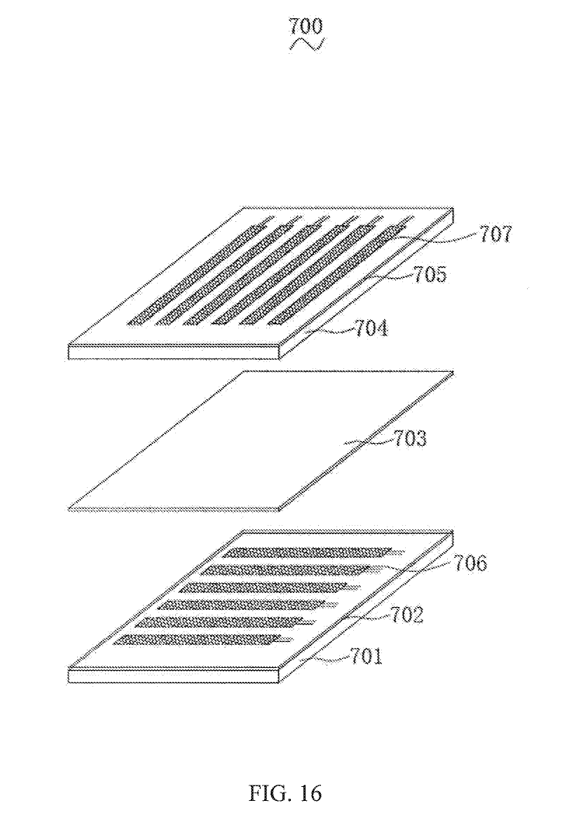

Referring to FIG. 15 and FIG. 16, another embodiment of the touch panel includes a glass cover plate 700′ and a touch sensing module 700.

The glass cover plate 700′ has a display area (not shown) and a non-display area (not shown) which is located at an outer edge of the display area and surrounds it. The glass cover plate 700′ can be an aluminosilicate glass plate or sodium calcium glass plate. The glass cover plate 700′ has a thickness of 0.3 mm to 1.2 mm, preferably 0.5 mm to 0.7 mm, which can ensure a fine light transmittance of the touch panel.

The touch sensing module 700 includes a first dielectric layer 702, an adhesive layer 703, a transparent substrate 704, and a second dielectric layer 705, which are laminated on the glass cover plate 700′ in that order. The touch sensing module 700 further includes a first conductive layer 706 and a second conductive layer 707 embedded in the first dielectric layer 702 and the second dielectric layer 705, respectively. The touch sensing module 700 further includes a first electrode trace and a second electrode trace embedded in the first dielectric layer 702 and the second dielectric layer 705, respectively. The first electrode trace and the second electrode trace are electrically coupled to the first conductive layer 706 and the second conductive layer 707, respectively. The first electrode trace and the second electrode trace are corresponding to the non-display area of the glass cover plate 700′.

The adhesive layer 702 and the transparent substrate 704 have the same structure and materials as that of the first adhesive layer 302 and the first transparent substrate 303 of the touch sensing module 300.

The first dielectric layer 702 and the second dielectric layer 704 have the same thicknesses and materials as that of the first dielectric layer 304 and the second dielectric layer 306 of the touch sensing module 300.

The first dielectric layer 702 defines a meshed first groove 7022 at a side thereof away from the glass cover plate 700′. The first groove 7022 is formed on the first dielectric layer 702 by using an imprinting mold. A depth-to-width ratio of the first groove 7022 is greater than or equals to 1. The second dielectric layer 705 defines a second groove 7052 on a side thereof away from the transparent substrate 704. The second groove 7052 is formed on the second dielectric layer 705 by using an imprinting mold. A depth-to-width ratio of the second groove 7052 is greater than or equals to 1.

The first conductive layer 706 and the second conductive layer 707 have the same structure as the first conductive layer 30 and the second conductive layer 50 of the forgoing embodiments. The first conductive layer 706 includes a plurality of first conductive strips extending along a first direction. The second conductive layer 707 includes a plurality of second conductive strips extending along a second direction. The first conductive layer 706 is received in the first groove 7022 and is embedded in the first dielectric layer 702, and the second conductive layer 707 is received in the second groove 7052 and embedded in the second dielectric layer 705. The thickness of the first conductive layer 706 is no greater than the depth of the first groove 7022, and the thickness of the second conductive layer 707 is no greater than the depth of the second groove 7052, so as to ensure that the first conductive layer 706 and the second conductive layer 707 are insulated from each other.

Projections of the first conductive strips on a plane where the second conductive strips are located intersect the second conductive strips to form a mutual capacitance without using conductive bridges, thus simplifying the procedure.

Preferably, the projections of the conductive wires of the first conductive layer 706 on a plane located by the second conductive layer 707 coincides with the conductive wires of the second conductive layer 707, so as to minimize the occupied area of the conductive wires of the first conductive layer 706 and the second conductive layer 707 on the visual area, thus increasing the light transmittance.

The thickness of the first conductive layer 706 and the second conductive layer 707 is in a range of from 1 μm to 10 μm, preferably from 2 μm to 5 μm.

The sensing area of the touch sensing module 700 is defined by the edges of the first conductive layer 706 and the second conductive layer 707.

The sensing area includes a visual area and a non-visual area located at an outer edge of the visual area. The visual area is aligned with the display area of the glass cover plate 700′, and a projection of the visual area on the glass cover plate 700′ coincides with the display area. The non-visual area is aligned with the non-display area of the glass cover plate 700′, and a projection of the non-visual area on the glass cover plate 700′ falls within the non-display area. Therefore the non-display area of the glass cover plate 700′ also has sensing features, which can enhance the user's experience. For example, the user can perform operations such as flipping, adjusting the volume, locking operating interface via touching the non-display area of the glass cover plate 700′.

In the illustrated embodiment, the number of the non-visual area is one, and the non-visual area is located at a side of the visual area. In alternative embodiment, the number of the non-visual area is two, and the two non-visual areas are located at opposite sides of the visual area.

The non-visual area has a strip-like shape with a width of d. In order to facilitating the touch, d is greater than 0.5 mm. In addition, d is no greater than the width of the non-display area, more preferably, d is no less than 1 mm.

The sensing area of the touch panel is defined by edges of the first conductive layer 706 and the second conductive layer 707. The sensing area includes a visual area and a non-visual area located at an outer edge of the visual area. The visual area is aligned with the display area, and the projection of the visual area on the glass cover plate 700′ coincides with the display area. The non-visual area is aligned with the non-display area, and the projection of the non-visual area on the glass cover plate 700′ falls within the non-display area, therefore the non-display area also has sensing features, which can enhance the user's experience.

The first conductive layer 706 and the second conductive layer 707 of the touch sensing module 700 are formed by filling conductive materials in the first groove 7022 and the second groove 7052, no etching process and bridge structure are needed during the fabrication, such that the cost of the raw materials is saved and the procedures are simplified. The metal conductive material can further reduce the price of the touch panel and increase the stability.

The described touch panel has a G1F (Glass-Film) structure, which can reduce a thickness of the film compared with the GFF structure and save the cost. In the illustrated embodiment, the first conductive layer 706 and the second conductive layer 707 are both located on the upper side of the dielectric layers.

Referring to FIG. 15, the touch panel further includes a shielding layer 708. The shielding layer 708 has the same shape as the non-display area, and a projection of the shielding layer 708 on the glass cover plate 700′ coincides with the non-display area.

The shielding layer 708 is positioned between the glass cover plate 700′ and the touch sensing module 700. In the illustrated embodiment, the shielding layer 708 is formed by shielding ink. In alternative embodiment, the shielding layer 708 may be made of chromium (Cr). The shielding layer 708 can shield the structures and components under the glass cover plate 700′ which are not necessary to be exposed, such as the frame circuit, so as to improve the appearance of the touch panel. It is to be understood that, in alternative embodiments, the shielding layer 708 can be omitted, as long as the structures and components are already covered by other structures.

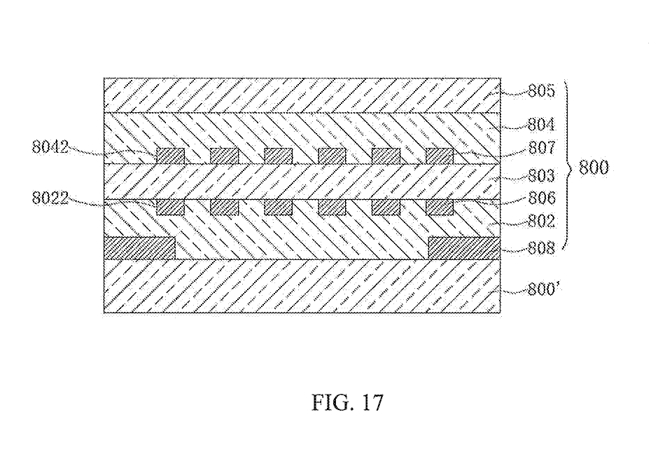

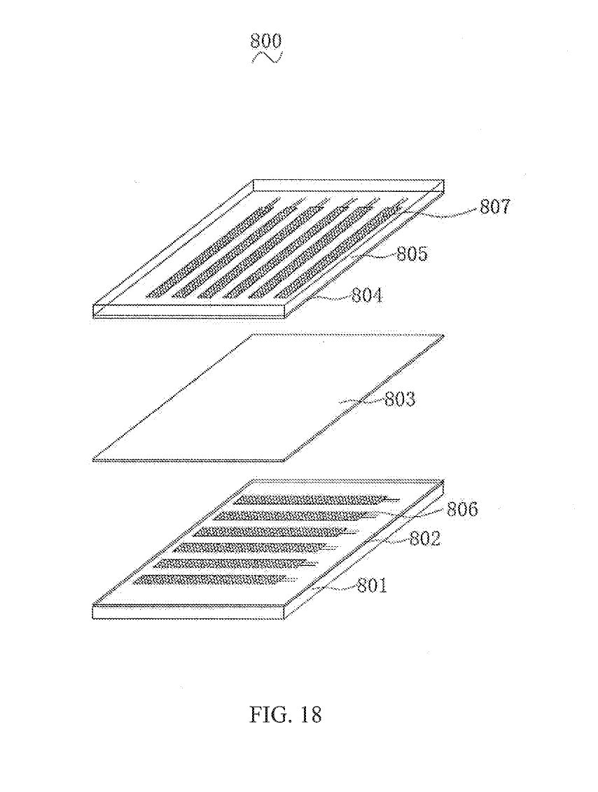

Referring to FIG. 17 and FIG. 18, another embodiment of the touch panel includes a glass cover plate 800′ and a touch sensing module 800.

The glass cover plate 800′ has a display area (not shown) and a non-display area (not shown) which is located at an outer edge of the display area and surrounds it. The glass cover plate 800′ can be an aluminosilicate glass plate or sodium calcium glass plate. The glass cover plate 800′ has a thickness of 0.3 mm to 1.2 mm, preferably 0.5 mm to 0.7 mm, which can ensure a fine light transmittance of the touch panel.

The touch sensing module 800 includes a first dielectric layer 802, an adhesive layer 803, a second dielectric layer 804, and a transparent substrate 805, which are laminated on the glass cover plate 800′ in that order. The touch sensing module 800 further includes a first conductive layer 806 and a second conductive layer 807 embedded in the first dielectric layer 802 and the second dielectric layer 804, respectively. The touch sensing module 800 further includes a first electrode trace and a second electrode trace embedded in the first dielectric layer 802 and the second dielectric layer 804, respectively. The first electrode trace and the second electrode trace are electrically coupled to the first conductive layer 806 and the second conductive layer 807, respectively. The first electrode trace and the second electrode trace are corresponding to the non-display area of the glass cover plate 800′.

The adhesive layer 803 and the transparent substrate 805 have the same structure and materials as that of the first adhesive layer 302 and the first transparent substrate 303 of the touch sensing module 300.

The first dielectric layer 802 and the second dielectric layer 804 have the same thicknesses and materials as that of the first dielectric layer 304 and the second dielectric layer 306 of the touch sensing module 300.

The first dielectric layer 802 defines a meshed first groove 8022 at a side thereof away from the glass cover plate 800′. The first groove 8022 is formed on the first dielectric layer 802 by using an imprinting mold. A depth-to-width ratio of the first groove 8022 is greater than or equals to 1. The second dielectric layer 804 defines a second groove 8042 on a side thereof away from the transparent substrate 805. The second groove 8042 is formed on the second dielectric layer 804 by using an imprinting mold. A depth-to-width ratio of the second groove 8042 is greater than or equals to 1.

The first conductive layer 806 and the second conductive layer 807 have the same structure as the first conductive layer 30 and the second conductive layer 50 of the forgoing embodiments. The first conductive layer 806 includes a plurality of first conductive strips extending along a first direction. The second conductive layer 807 includes a plurality of second conductive strips extending along a second direction. The first conductive layer 806 is received in the first groove 8022 and is embedded in the first dielectric layer 802, and the second conductive layer 807 is received in the second groove 8042 and embedded in the second dielectric layer 804. The thickness of the first conductive layer 806 is no greater than the depth of the first groove 8022, and the thickness of the second conductive layer 807 is no greater than the depth of the second groove 8042, so as to ensure that the first conductive layer 806 and the second conductive layer 807 are insulated from each other.

Projections of the first conductive strips on a plane where the second conductive strips are located intersect the second conductive strips to form a mutual capacitance without using conductive bridges, thus simplifying the procedure.

Preferably, the projections of the conductive wires of the first conductive layer 806 on a plane located by the second conductive layer 807 coincides with the conductive wires of the second conductive layer 807, so as to minimize the occupied area of the conductive wires of the first conductive layer 806 and the second conductive layer 807 on the visual area, thus increasing the light transmittance.

The thickness of the first conductive layer 806 and the second conductive layer 807 is in a range of from 1 μm to 10 μm, preferably from 2 μm to 5 μm.

The sensing area of the touch sensing module 800 is defined by the edges of the first conductive layer 806 and the second conductive layer 807.

The sensing area includes a visual area and a non-visual area located at an outer edge of the visual area. The visual area is aligned with the display area of the glass cover plate 800′, and a projection of the visual area on the glass cover plate 800′ coincides with the display area. The non-visual area is aligned with the non-display area of the glass cover plate 800′, and a projection of the non-visual area on the glass cover plate 800′ falls within the non-display area. Therefore the non-display area of the glass cover plate 800′ also has sensing features, which can enhance the user's experience. For example, the user can perform operations such as flipping, adjusting the volume, locking operating interface via touching the non-display area of the glass cover plate 800′.

In the illustrated embodiment, the number of the non-visual area is one, and the non-visual area is located at a side of the visual area. In alternative embodiment, the number of the non-visual area is two, and the two non-visual areas are located at opposite sides of the visual area.

The non-visual area has a strip-like shape with a width of d. In order to facilitating the touch, d is greater than 0.5 mm. In addition, d is no greater than the width of the non-display area, more preferably, d is no less than 1 mm.

The sensing area of the touch panel is defined by edges of the first conductive layer 806 and the second conductive layer 807. The sensing area includes a visual area and a non-visual area located at an outer edge of the visual area. The visual area is aligned with the display area, and the projection of the visual area on the glass cover plate 800′ coincides with the display area. The non-visual area is aligned with the non-display area, and the projection of the non-visual area on the glass cover plate 800′ falls within the non-display area, therefore the non-display area also has sensing features, which can enhance the user's experience.

The first conductive layer 806 and the second conductive layer 807 of the touch sensing module 800 are formed by filling conductive materials in the first groove 8022 and the second groove 8042, no etching and bridge structure is needed during the fabrication, such that the cost of the raw materials is saved and the procedures are simplified. The metal conductive material can further reduce the price of the touch panel and increase the stability.

The described touch panel has a G1F (Glass-Film) structure, which can reduce a thickness of the film compared with the GFF structure and save the cost. In the illustrated embodiment, the first conductive layer 806 and the second conductive layer 807 are face-to-face configured.

Referring to FIG. 17, the touch panel further includes a shielding layer 808. The shielding layer 808 has the same shape as the non-display area, and a projection of the shielding layer 808 on the glass cover plate 800′ coincides with the non-display area.

The shielding layer 808 is positioned between the glass cover plate 800′ and the touch sensing module 800. In the illustrated embodiment, the shielding layer 808 is formed by shielding ink. In alternative embodiment, the shielding layer 808 may be made of chromium (Cr). The shielding layer 808 can shield the structures and components under the glass cover plate 800′ which are not necessary to be exposed, such as the frame circuit, so as to improve the appearance of the touch panel. It is to be understood that, in alternative embodiments, the shielding layer 808 can be omitted, as long as the structures and components are already covered by other structures.

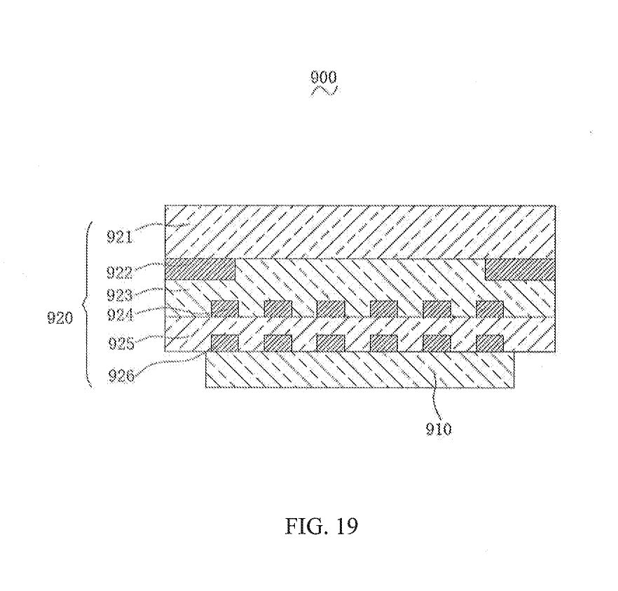

Referring to FIG. 19, a touch display device 900 is further provided, which includes a display 910 and a touch panel 920.

The touch panel 920 has the same structure as the touch panel shown in FIG. 3. The touch panel 920 includes a glass cover plate 921, a shielding layer 922, a first dielectric layer 923, a first conductive layer 924, a second dielectric layer 925, a second conductive layer 926, a first electrode trace (not shown), and a second electrode trace (not shown).

The second dielectric layer 925, the first dielectric layer 923, and the glass cover plate 921 are laminated on the display 910 in that order. The first conductive layer 924 and the second conductive layer 925 are embedded in the first dielectric layer 923 and the second dielectric layer 925. The shielding layer 922 is positioned between the glass cover plate 921 and the first dielectric layer 923. The first electrode trace and the second electrode trace are embedded in the first dielectric layer 923 and the second dielectric layer 925, respectively. The first electrode trace and the second electrode trace are electrically coupled to the first conductive layer 924 and the second conductive layer 926.

The non-display area of the glass cover plate 921 also has sensing features, which can enhance the user's experience of the touch display device 900. In addition, the touch panel 920 has a simple fabrication process, low cost, and stable performance, so that the touch display device 900 has a lower price and a more stable performance.

It is to be understood that, in alternative embodiments, the touch panel 920 may has the same structure as the touch panel shown in FIG. 7, FIG. 9, FIG. 11, FIG. 13, FIG. 15, and FIG. 17.

Although the present invention has been described with reference to the embodiments thereof and the best modes for carrying out the present invention, it is apparent to those skilled in the art that a variety of modifications and changes may be made without departing from the scope of the present invention, which is intended to be defined by the appended claims.

What is claimed is:

1. A touch panel, comprising:
a glass cover plate comprising a display area and a non-display area located at an outer edge of the display area; and
a touch sensing module laminated on the glass cover plate;
wherein the touch sensing module comprises a first conductive layer and a second conductive layer laminated in a thickness direction of the glass cover plate, the first conductive layer comprises a plurality of first conductive strips extending along a first direction, the plurality of first conductive strips are spaced and insulated from each other; the second conductive layer comprises a plurality of second conductive strips extending along a second direction, the plurality of second conductive strips are spaced and insulated from each other; projections of the first conductive strips on a plane where the second conductive strips are located intersect the second conductive strips; the touch sensing module comprises a sensing area defined by edges of the first conductive layer and the second conductive layer, the sensing area comprises a visual area and a non-visual area located at an outer edge of the visual area, a projection of the visual area on the glass cover plate coincides with the display area, a projection of the non-visual area on the glass cover plate falls within the non-display area.

2. The touch panel according to claim 1, wherein the non-visual area has a strip-like shape, a width of the non-visual area is greater than 0.5 mm but less than the width of the non-display area.

3. The touch panel according to claim 2, wherein the width of the non-visual area is greater than or equal to 1 mm.

4. The touch panel according to claim 1, wherein the number of the non-visual area is two, the two non-visual areas are located at opposite sides of the visual area.

5. The touch panel according to claim 1, further comprising a first dielectric layer and a second dielectric layer laminated on the glass cover plate in a thickness direction thereof, wherein the first dielectric layer defines a meshed first groove, the second dielectric layer defines a meshed second groove, the first conductive strip and the second conductive strip comprises meshed conductive wires intersected with each other, the first conductive strips and the second conductive strips are received in the first groove and the second groove, respectively; the conductive wires are formed by curing conductive materials filled in the first groove and the second groove.

6. The touch panel according to claim 5, wherein the conductive wires have a width from 0.2 μm to 5 μm.

7. The touch panel according to claim 5, further comprising a first adhesive layer, a second adhesive layer, a first transparent substrate, and a second transparent substrate, wherein the first adhesive layer, the first dielectric layer, the first transparent substrate, the second adhesive layer, the second transparent substrate, and the second dielectric layer are laminated on the glass cover plate in that order.

8. The touch panel according to claim 5, further comprising a first adhesive layer, a second adhesive layer, a first transparent substrate, and a second transparent substrate, wherein the first adhesive layer, the first dielectric layer, the first transparent substrate, the second adhesive layer, the second dielectric layer, and the second transparent substrate are laminated on the glass cover plate in that order.

9. The touch panel according to claim 5, further comprising an adhesive layer and a transparent substrate, wherein the adhesive layer, the first dielectric layer, the transparent substrate, and the second dielectric layer are laminated on the glass cover plate in that order.

10. The touch panel according to claim 5, further comprising an adhesive layer and a transparent substrate, wherein the first dielectric layer, the adhesive layer, the second dielectric layer, and the transparent substrate are laminated on the glass cover plate in that order.

11. The touch panel according to claim 5, further comprising an adhesive layer and a transparent substrate, wherein the first dielectric layer, the adhesive layer, the transparent substrate, and the second dielectric layer are laminated on the glass cover plate in that order.

12. The touch panel according to claim 5, wherein a distance between two adjacent conductive wires in the first conductive layer and the second conductive layer is in a range from 50 μm to 1000 μm.

13. The touch panel according to claim 1, wherein the first conductive layer and the second conductive layer has a thickness from 1 μm to 10 μm.

14. The touch panel according to claim 5, wherein a thickness of the first conductive layer is less than or equal to a depth of the first groove; a thickness of the second conductive layer is less than or equal to a depth of the second groove, a depth-to-width ratio of the first groove and the second groove is greater than or equal to 1.

15. The touch panel according to claim 5, further comprising a shielding layer located between the glass cover plate and the touch sensing module, wherein a projection of the shielding layer on the glass cover plate coincides with the non-display area.

16. The touch panel according to claim 15, wherein the shielding layer is made of shielding ink.

17. A touch display device, comprising a display and a touch panel according to claim 1, wherein a projection of the display area of the glass cover plate on the display falls within the display.
